(19) United States
(12) Patent Application Publication
(10) Pub. No.: US 2026/0217328 A1
(43) Pub. Date: Jul. 30, 2026

(54) COMPOSITE MATERIAL AND BICYCLE COMPONENT AND METHOD OF FORMING THE SAME

(71) Applicant: INDUSTRIAL TECHNOLOGY RESEARCH INSTITUTE, Hsinchu (TW)

(72) Inventors: Hung-Jen LIU, Hsinchu City (TW); Hsin-Ching KAO, Baoshan Township (TW); Shihn-Juh LIOU, Hsinchu City (TW); Pei-Yin CHEN, Taipei City (TW)

(73) Assignee: INDUSTRIAL TECHNOLOGY RESEARCH INSTITUTE, Hsinchu (TW)

(21) Appl. No.: 19/002,300

(22) Filed: Dec. 26, 2024

Related U.S. Application Data
(60) Provisional application No. 63/623,513, filed on Jan. 22, 2024.

(30) Foreign Application Priority Data
Nov. 4, 2024 (TW) 113142110

(51) Int. Cl. B62J 1/08; B29C 45/00; B29K 77/00; B29K 307/04; B29L 31/30; C08K 7/06; C08K 9/02

(52) U.S. Cl. CPC B62J 1/08; B29C 45/0005; C08K 7/06; C08K 9/02; B29K 2077/10; B29K 2307/04; B29L 2031/3094; C08K 2201/004; C08K 2201/014

(57) ABSTRACT

A composite material includes 100 parts by weight of aromatic polyamide; 30 to 55 parts by weight of carbon fibers; and 10 to 35 parts by weight of carbon fibers having surface-attached carbon nanotubes. The composite material can be used to form a one-piece bicycle component such as a saddle connected to a rail.

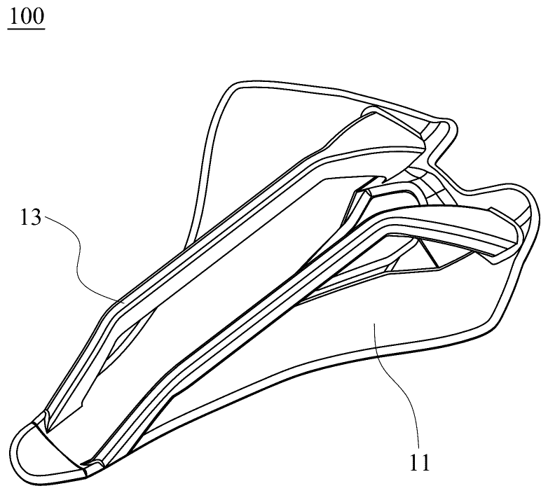

### CROSS REFERENCE TO RELATED APPLICATIONS

This application claims the benefit of U.S. Provisional Application No. 63/623,513, filed on Jan. 22, 2024, the entirety of which is/are incorporated by reference herein.

The present application is based on, and claims priority from, Taiwan Application Serial Number 113142110, filed Nov. 4, 2024, the disclosure of which is hereby incorporated by reference herein in its entirety.

### TECHNICAL FIELD

The technical field relates to a composite material, and in particular it relates to a one-piece bicycle component (such as a saddle integrated with a rail) made of the composite material.

### BACKGROUND

In the bicycle manufacturing industry, a conventional saddle and rail are two separate pieces, such as a plastic-based saddle and a metal rail. In general, a plastic-based saddle is formed first, and a metal rail is then attached to the plastic-based saddle. The above process can be complicated and time-consuming. Because conventional carbon fiber reinforced plastic (CFRP) cannot be injection processed, it cannot be used to fabricate a one-piece saddle and rail. On the other hand, conventional injection molding materials have insufficient flexural strength, flexural modulus, and impact resistance, and therefore cannot be used to fabricate a one-piece bicycle component (such as a saddle integrated with a rail).

Accordingly, a novel composite material having sufficient flexural strength, flexural modulus, and impact resistance is called for to fabricate a one-piece bicycle component (such as a saddle integrated with a rail).

### SUMMARY

One embodiment of the disclosure provides a composite material, including: 100 parts by weight of aromatic polyamide; 30 to 55 parts by weight of carbon fibers; and 10 to 35 parts by weight of carbon fibers having surface-attached carbon nanotubes.

In some embodiments, the aromatic polyamide includes

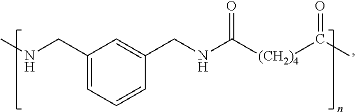

wherein n is a repeating number, and the aromatic polyamide has a relative viscosity of 2.1 to 2.4.

In some embodiments, the carbon fibers are chopped carbon fibers having a length of 200 micrometers to 400 micrometers.

In some embodiments, the composite material has a flexural strength of 400 MPa to 450 MPa.

In some embodiments, the composite material has a flexural modulus of greater than 30 GPa and less than or equal to 35 GPa.

In some embodiments, the composite material has an impact resistance of 10.7 Kgf to 13.5 Kgf.

One embodiment of the disclosure provides a bicycle component, including a saddle; and a rail connected to the saddle, wherein the saddle and the rail are one-piece formed from the described composite material.

In some embodiments, the bicycle component has a weight of 120 g to 150 g.

One embodiment of the disclosure provides a method of forming a bicycle component, including one-piece molding the described composite material to form a saddle and a rail connected to each other.

In some embodiments, the step of one-piece molding the described composite material includes injection molding.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIGURE shows a bicycle component in one embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

One embodiment of the disclosure provides a composite material, including: 100 parts by weight of aromatic polyamide; 30 to 55 parts by weight of carbon fibers; and 10 to 35 parts by weight of carbon fibers having surface-attached carbon nanotubes. If there are too few carbon fibers, the flexural strength, the flexural modulus, and the impact resistance of the composite material will be insufficient. If there are too many carbon fibers, they will float on the surface of the product, and the product cannot be used. If there are too few carbon fibers having surface-attached carbon nanotubes, the flexural strength, the flexural modulus, and the impact resistance of the composite material will be insufficient. If there are too many carbon fibers having surface-attached carbon nanotubes, the composite material will be too expensive to be used in practice.

In some embodiments, the aromatic polyamide includes

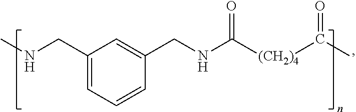

wherein n is a repeating number, and the aromatic polyamide has a relative viscosity of 2.1 to 2.4 (measured according to the standard ASTM D789). A higher relative viscosity of the aromatic polyamide means a larger molecular weight of the aromatic polyamide (i.e., larger n value). If the relative viscosity of the aromatic polyamide is too low (i.e., the molecular weight of the aromatic polyamide is too low), the material itself will have a poor strength, which may affect the mechanical characteristics of the composite material. If the relative viscosity of the aromatic polyamide is too high (i.e., the molecular weight of the aromatic polyamide is too high), its flowability will be poor and is not beneficial to injection molding. On the other hand, if another aromatic polyamide such as PA6I, PA6T, PA66/6I, PA66/6T, or the like is selected, the flexural strength, the flexural modulus, and the impact resistance of the composite material may be insufficient, or the process temperature will be too high to mold the composite material.

In some embodiments, the carbon fibers are chopped carbon fibers having a length of 200 micrometers to 400 micrometers. If the carbon fibers are too short, they will be expensive and difficult to purchase. If the carbon fibers are too long, the flexural strength, the flexural modulus, and the impact resistance of the composite material will be insufficient.

In some embodiments, the carbon fibers having surface-attached carbon nanotubes are Namd™ commercially available from Nitta. Namd™ is a technology developed from multi-layered multi-walled carbon nanotubes (MWCNT) to continuously attach carbon nanotubes to the surface of carbon fibers. MWCNT has a diameter of 10 to 20 nanometers and a length of several micrometers. While MWCNT attach to the surface of the carbon fibers through intermolecular force, the characteristics of MWCNT (e.g., conductivity and impact resistance) will not be degraded. Note that if the carbon fibers having surface-attached carbon nanotubes are replaced with conventional carbon nanotubes, the flexural strength, the flexural modulus, and the impact resistance of the composite material will be decreased.

In some embodiments, the composite material has a flexural strength of 400 MPa to 450 MPa. If the flexural strength of the composite material is too low, the composite material cannot satisfy the application requirement of high intensity (such as a bicycle component).

In some embodiments, the composite material has a flexural modulus of greater than 30 GPa and less than or equal to 35 GPa. If the flexural modulus of the composite material is too low, the composite material cannot satisfy the application requirement of high intensity. For example, a bicycle component often requires high flexural resistance.

In some embodiments, the composite material has an impact resistance of 10.7 Kgf to 13.5 Kgf. If the impact resistance of the composite material is too low, the composite material cannot satisfy the application requirement of high intensity.

As shown in FIGURE, one embodiment of the disclosure provides a bicycle component 100, which includes a saddle 11 and a rail 13 connected to the saddle 11. The saddle 11 and the rail 13 are one-piece formed from the described composite material. It should be understood that the bicycle component 100 in FIGURE is only for illustration, and one skilled in the art may adjust the shapes and the locations of the saddle 11 and the rail 13 according to the requirements, as long as the saddle 11 and the rail 13 are connected to each other and have the functions of the saddle 11 and the rail 13 as defined in this technical field. The saddle 11 and the rail 13 are not limited to the manner as shown in FIGURE.

In some embodiments, the bicycle component has a weight of 120 g to 150 g. Because the saddle 11 and the rail 13 are formed by one-piece molding, their weight is much less than a total weight of a conventional saddle and a metal rail (about ⅓ the total weight of the traditional saddle and the metal rail).

One embodiment of the disclosure provides a method of forming a bicycle component, including one-piece molding the described composite material to form the saddle 11 and the rail 13 connected to each other.

In some embodiments, the step of one-piece molding the described composite material includes injection molding. Compared to the conventional method such as forming a saddle and then assembling a metal rail onto the saddle, one-piece molding (e.g., injection molding) the saddle 11 and the rail 13 connected to each other is easier and efficiently decreasing the process time and cost.

For example, the composite material can be heated to 230° C. to 270° C. in an injection cylinder, then injected by a pressure of 50 MPa to 120 MPa to a mold at 120° C. to 160° C., and then cooled for 80 seconds to 120 seconds to obtain a product such as the bicycle component 100 (e.g., the saddle 11 and the rail 13 connected to each other). It should be understood that the composite material is not only used to form the one-piece bicycle component 100 (e.g., the saddle 11 and the rail 13 connected to each other), but also used to form other products that can be assembled with other components. In other words, the composite material is not limited to form a one-piece product.

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### EXAMPLES

In following Examples, the aromatic polyamide had a chemical structure of

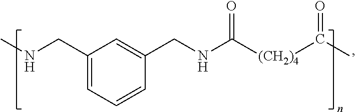

having a relative viscosity of 2.1 to 2.4 (measured according to the standard ASTM D789), which was S6001-MXD6 commercially available from Mitsubishi Chemical.

Another aromatic polyamide PA66/6I had a chemical structure of

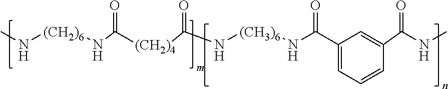

having a relative viscosity of 2.2 to 2.4 (measured according to the standard ASTM D789), which was commercially available from Arkema SA. The chopped carbon fibers was TC42 commercially available from TAIRYLAN, and the carbon fibers having surface-attached carbon nanotubes was Namd™ commercially available from Nitta.

In following Examples, the flexural strength and the flexural modulus of the composite material were measured according to the standard ASTM D790, and the impact resistance of the composite material was measured according the standard ASTM D256.

### Comparative Example 1

100 parts by weight of the aromatic polyamide S6001-MXD6, 58 parts by weight of the chopped carbon fibers TC42, and 8 parts by weight of the carbon fibers having surface-attached carbon nanotubes (Namd™) were put into a twin screw extruder to be blended and pelletized to form a composite material. The composite material had a flexural strength of 383 MPa, a flexural modulus of 28 GPa, and an impact resistance of 10.3 Kgf. As shown in Comparative Example 1, when there were too few carbon fibers having surface-attached carbon nanotubes (Namd™), the composite material had insufficient flexural strength, flexural modulus, and impact resistance.

### Example 1

100 parts by weight of the aromatic polyamide S6001-MXD6, 50 parts by weight of the chopped carbon fibers TC42, and 16 parts by weight of the carbon fibers having surface-attached carbon nanotubes (Namd™) were put into a twin screw extruder to be blended and pelletized to form a composite material. The composite material had a flexural strength of 413 MPa, a flexural modulus of 33 GPa, and an impact resistance of 12.8 Kgf.

The composite material was injection molded to form a one-piece bicycle component 100, which includes a saddle 11 connected to a rail 13, as shown in FIGURE. The temperature of the injection cylinder was 265° C., the mold temperature was 150° C., the injection pressure was 50 MPa, the injection period was 30 seconds, and the cooling period was 90 seconds. The weight of the product was only 146 g (about ⅓ the total weight of the conventional saddle and the metal rail). The product had a density of 1.40 g/cm³.

### Example 2

100 parts by weight of the aromatic polyamide S6001-MXD6, 42 parts by weight of the chopped carbon fibers TC42, and 25 parts by weight of the carbon fibers having surface-attached carbon nanotubes (Namd™) were put into a twin screw extruder to be blended and pelletized to form a composite material. The composite material had a flexural strength of 407 MPa, a flexural modulus of 31.6 GPa, and an impact resistance of 12.5 Kgf.

### Example 3

100 parts by weight of the aromatic polyamide S6001-MXD6, 33 parts by weight of the chopped carbon fibers TC42, and 33 parts by weight of the carbon fibers having surface-attached carbon nanotubes (Namd™) were put into a twin screw extruder to be blended and pelletized to form a composite material. The composite material had a flexural strength of 419 MPa, a flexural modulus of 32 GPa, and an impact resistance of 12.5 Kgf.

### Comparative Example 2

100 parts by weight of the aromatic polyamide S6001-MXD6 and 67 parts by weight of the chopped carbon fiber TC42 were put into a twin screw extruder to be blended and pelletized to form a composite material. The composite material had a flexural strength of 391 MPa, a flexural modulus of 28 GPa, and an impact resistance of 10.6 Kgf. As shown in Comparative Example 2, if the carbon fibers having surface-attached carbon nanotubes was omitted, the flexural strength, the flexural modulus, and the impact resistance of the composite material would be insufficient.

### Comparative Example 3

100 parts by weight of the aromatic polyamide PA66/6I and 67 parts by weight of the chopped carbon fibers TC42 were put into a twin screw extruder to be blended and pelletized to form a composite material. The composite material had a flexural strength of 400 MPa, a flexural modulus of 25 GPa, and an impact resistance of 14.9 Kgf. As shown in Comparative Example 3, if the carbon fibers having surface-attached carbon nanotubes was omitted, the flexural strength and the flexural modulus of the composite material would be insufficient.

### Comparative Example 4

A composite material NL8340 (commercially available from Great Eastern Resins Industrial Co. Ltd.) included 100 parts by weight of the aromatic polyamide S6001-MXD6 and 67 parts by weight of the long carbon fibers. The composite material had a flexural strength of 369 MPa, a flexural modulus of 27 GPa, and an impact resistance of 13.9 Kgf.

### Comparative Example 5

A composite material 6128 (commercially available from Akroloy) included 100 parts by weight of the aromatic polyamide and 67 parts by weight of carbon fibers. The composite material had a flexural strength of 322 MPa, a flexural modulus of 27 GPa, and an impact resistance of 8.9 Kgf.

### Comparative Example 6

100 parts by weight of the aromatic polyamide S6001-MXD6, 50 parts by weight of the chopped carbon fibers TC42, and 16 parts by weight of carbon nanotubes (MWCNT commercially available from Techinstro) were put into a twin screw extruder to be blended and pelletized to form a composite material. The composite material had a flexural strength of 402 MPa and a flexural modulus of 30 GPa. As shown in Comparative Example 6, if the carbon fibers having surface-attached carbon nanotubes (Namd™) was replaced with the carbon nanotubes, the flexural strength and the flexural modulus of the composite material would be decreased (e.g., compared to Example 1).

### Comparative Example 7

100 parts by weight of the aromatic polyamide S6001-MXD6 and 100 parts by weight of the chopped carbon fibers TC42 were put into a twin screw extruder to be blended and pelletized to form a composite material. The composite material had a flexural strength of 435 MPa, a flexural modulus of 30 GPa, and an impact resistance of 14 Kgf. However, after the composite material being injection molded to form a one-piece bicycle component (including a saddle connected to a rail), the carbon fibers floated on the surface of the product, and the product could not be used.

It will be apparent to those skilled in the art that various modifications and variations can be made to the disclosed methods and materials. It is intended that the specification and examples be considered as exemplary only, with the true scope of the disclosure being indicated by the following claims and their equivalents.

What is claimed is:

1. A composite material, comprising:
100 parts by weight of aromatic polyamide;
30 to 55 parts by weight of carbon fibers; and
10 to 35 parts by weight of carbon fibers having surface-attached carbon nanotubes.

2. The composite material as claimed in claim 1, wherein the aromatic polyamide comprises 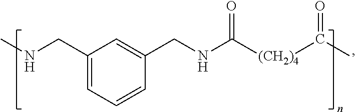
wherein n is a repeating number, and the aromatic polyamide has a relative viscosity of 2.1 to 2.4.

3. The composite material as claimed in claim 1, wherein the carbon fibers are chopped carbon fibers having a length of 200 micrometers to 400 micrometers.

4. The composite material as claimed in claim 1, wherein the composite material has a flexural strength of 400 MPa to 450 MPa.

5. The composite material as claimed in claim 1, wherein the composite material has a flexural modulus of greater than 30 GPa and less than or equal to 35 GPa.

6. The composite material as claimed in claim 1, wherein the composite material has an impact resistance of 10.7 Kgf to 13.5 Kgf.

7. A bicycle component, comprising:
a saddle; and
a rail connected to the saddle,
wherein the saddle and the rail are one-piece formed from the composite material as claimed in claim 1.

8. The bicycle component as claimed in claim 7, wherein the bicycle component has a weight of 120 g to 150 g.

9. A method of forming a bicycle component, comprising:
one-piece molding the composite material as claimed in claim 1 to form a saddle and a rail connected to each other.

10. The method as claimed in claim 9, wherein the step of one-piece molding the composite material as claimed in claim 1 comprises injection molding.
